(19) United States
(12) Patent Application Publication
(10) Pub. No.: US 2022/0067836 A1
(43) Pub. Date: Mar. 3, 2022

(54) DETERMINING INVESTMENT OPPORTUNITY

(71) Applicant: International Business Machines Corporation, Armonk, NY (US)

(72) Inventors: JOHN DAVID MCCRORIE, II, HOOVER, AL (US); Sumanta Kumar ADHIKARI, Kolkata (IN); Somsankar BANERJEE, Kolkata (IN); SARADINDU DATTA, Chandannagar (IN)

(21) Appl. No.: 17/011,053

(22) Filed: Sep. 3, 2020

(51) Int. Cl. G06Q 40/06; G06N 20/00; G06F 16/29; G06Q 30/02

(52) U.S. Cl. CPC G06Q 40/06; G06Q 30/0205; G06F 16/29; G06N 20/00

(57) ABSTRACT

Embodiments are disclosed for a method. The method includes receiving local opportunity index (LOI) indicator values representing multiple categories of development for a geographical community. The method also includes removing noise from the LOI indicator values. Additionally, the method includes generating an LOI score based on the LOI indicator values having the noise removed. Further, the LOI score is based on LOI indicator scores corresponding to types of the LOI indicator values. The method further includes generating a multivariate scenario analysis having a new LOI score based on the LOI indicator values and an alternate LOI indicator value.

### BACKGROUND

The present disclosure relates to investment opportunity, and more specifically, to determining investment opportunity.

The Opportunity Index® is a numerical representation of the socio-economic opportunity for communities in the United States. This index includes various indicators that can represent the level of socio-economic opportunity in a specific geographic region, e.g., a U.S. county. This index is a composite that includes indicators in four different dimensions of opportunity: Economy, Education, Health, and Community. However, this approach has several challenges, including, for example, outdated or inaccurate information about a community. Such inaccuracies can make a tool, such as the Opportunity Index®, an inaccurate representation of a community's opportunities.

### SUMMARY

Embodiments are disclosed for a method. The method includes receiving local opportunity index (LOI) indicator values representing multiple categories of development for a geographical community. The method also includes removing noise from the LOI indicator values. Additionally, the method includes generating an LOI score based on the LOI indicator values having the noise removed. Further, the LOI score is based on LOI indicator scores corresponding to types of the LOI indicator values. The method further includes at least one selected from a group consisting of: generating a multivariate scenario analysis having a new LOI score based on the LOI indicator values and an alternate LOI indicator value; and, generating an investment recommendation based on the local opportunity index and a specified resource amount.

Further aspects of the present disclosure are directed toward systems and computer program products with functionality similar to the functionality discussed above regarding the computer-implemented methods. The present summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an example system for generating a Local Opportunity Index, in accordance with some embodiments of the present disclosure.

FIG. 2 is a block diagram of an example process for generating a Local Opportunity Index, in accordance with some embodiments of the present disclosure.

FIG. 3 is a block diagram of an example user input interface for multivariate scenario analysis, in accordance with some embodiments of the present disclosure.

FIG. 4 is a block diagram of an example results interface for multivariate scenario analysis, in accordance with some embodiments of the present disclosure.

FIG. 5 is a block diagram of an example interface for identifying community investment opportunities, in accordance with some embodiments of the present disclosure.

FIG. 6 is a block diagram of example modeling and hierarchical processes in a system for generating a Local Opportunity Index, in accordance with some embodiments of the present disclosure.

FIG. 7 is a block diagram of an example process flow diagram of a method for generating a Local Opportunity Index, in accordance with some embodiments of the present disclosure.

FIG. 8 is a block diagram of an example LOI server, in accordance with some embodiments of the present disclosure.

FIG. 9 is a cloud computing environment, according to some embodiments of the present disclosure.

FIG. 10 is a set of functional abstraction model layers provided by cloud computing environment, according to some embodiments of the present disclosure, is shown.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

As stated previously, identifying socio-economic opportunity can be challenging if the information used to identify such opportunity is not representative of the cities, towns, and other communities. One challenge with accuracy may stem from the lack of a statistically robust methodology to combine the underlying indicators into the Opportunity Index® value. Additionally, this index is not available in a useful software tool, for example, that could enable community leaders to put the index to work in a practical application like identifying socio-economic opportunities in specific communities.

Accordingly, embodiments of the present disclosure provide a Local Opportunity Index (LOI) that can provide a more accurate, more robust, representation of a community, than current indices. Additionally, embodiments may incorporate the LOI into a scenario planning tool that can forecast future LOI under different scenarios. In this way, such embodiments can enable community leaders to identify how different types of investment can affect their communities. Accordingly, community leaders (with resources to spend) can make the types of investments that may serve their communities' interests.

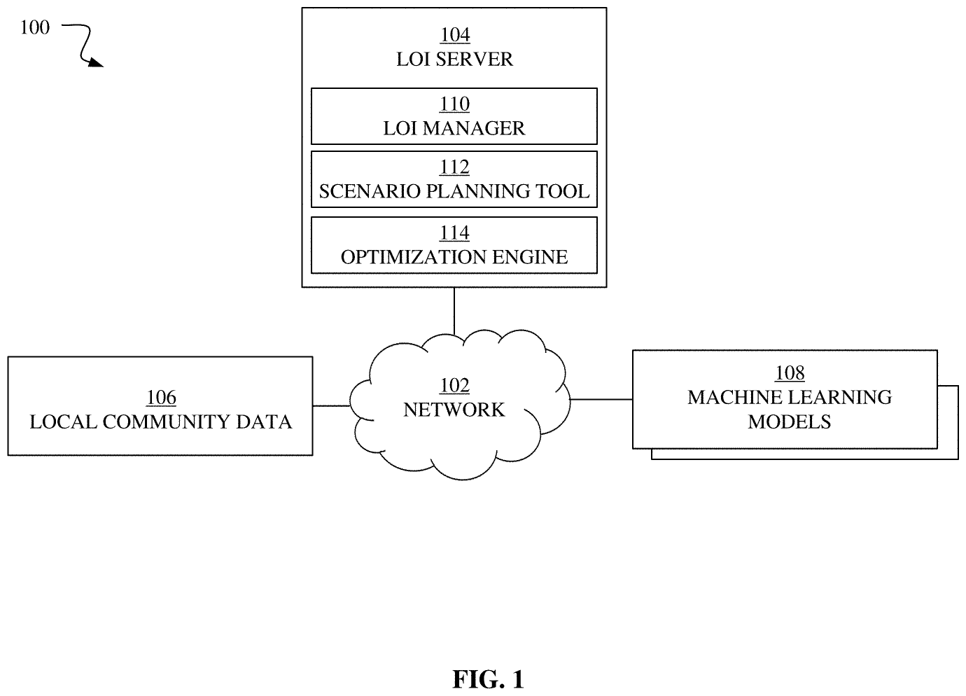

FIG. 1 is a block diagram of an example system 100 for generating a Local Opportunity Index, in accordance with some embodiments of the present disclosure. The system 100 includes a network 102, LOI server 104, local community data 106, and machine learning models 108. The network 102 may be a local area network, wide area network, or collection of computer communication networks. In some embodiments, the network 102 can be the Internet.

The LOI server 104 can include one or more computer nodes having installed thereon an LOI manager 110, a scenario planning tool 112, and an optimization engine 114. The LOI manager 110 can collect the local community data 106 and employ a robust statistical methodology to generate an LOI for specific communities. The LOI can be a numerical value ranging from 0-100 that indicates the economic investment opportunity available in a community, wherein the value of the LOI increases as the investment increase. In other words, the higher a community's LOI score is, the more likely it is that the citizens of that community will be successful, overall and/or in a specific dimension. For example, a person planning to move to a new city (metropolitan area) may ask, “Which local community would be the most likely to enable my family to succeed?” By looking at the LOI score, it is possible to determine an answer.

The communities can include contiguous geographic regions, for example, ranging from neighborhoods to states (in the U.S., and/or throughout the world). In some embodiments of the present disclosure, the communities can include Public Use Microdata Areas (PUMAs). The U.S. Census Bureau, for example, organizes its decennial data collection by PUMA. The PUMA is a geographically contiguous region of the United States having a population of at least 100,000. The PUMAs are used for collecting and reporting data about these communities. Each state of the United States is broken down into multiple PUMAs.

In some embodiments of the present disclosure, the LOI manager 110 can consolidate publicly available data and clean this data to mitigate data irregularities. For example, the local community data 106 may be publicly available data that is collected at different levels of granularity (e.g., city, county, and the like) from respective sources, such as, the U.S. Census Bureau, Civil Rights Data Collection, Bureau of Economic Analysis, Centers for Disease Control and Prevention, the Health Resources and Services Administration, and the like. Accordingly, the LOI manager 110 can collect the local community data 106 from different public sources and transform the data into a consistent community level of granularity. Further, the LOI manager 110 can employ a well-defined methodology to remove noise from the local community data 106.

In some embodiments of the present disclosure, the LOI manager 110 can generate the LOI using multiple indicators (LOI indicators), representing four different dimensions of a community's socio-economic condition and/or strength in terms of economy, education, community, and physical health. Thus, each dimension includes a subset of the LOI indicators.

In the economic dimension, the LOI indicators can include: employment rate, wages, income inequality percentage, poverty among youth percentage, poverty among the workforce percentage, poverty among senior citizens percentage, housing expense, local gross domestic product (GDP), income to poverty percentage, broadband internet subscription percentage, and fiscal equity percentage. Fiscal equity can be calculated using data (e.g., at the school district level of granularity) that shows the inequality of distribution of aided funds for every school. This LOI indicator can be calculated using the McLoone index formula, FE=SEBM/(ME*N), where FE=Fiscal Equity; SEBM=Total expenditure per student below median expenditure for particular school district; ME=Median Expenditure per student at school district level; and, N=The number of schools within the school district with per student expenditure below median expenditure level. Additionally, the FE can be adjusted to the PUMA and/or Zone Improvement Plan Code (ZIP Code) level of granularity.

In the educational dimension, the LOI indicators can include: post-secondary completion percentage, science-technology-engineering-math (STEM) readiness percentage, student detachment percentage, high school credential percentage, teacher absenteeism percentage, post-secondary enrollment percentage, high school enrollment percentage, pre-school enrollment percentage, and student absenteeism percentage.

In the community dimension, the LOI indicators can include school safety percentage, high school disconnection percentage, post-secondary disconnection percentage, and workforce disconnection percentage.

In the health dimension, the LOI indicators can include: probability of low birth weight, health insurance coverage percentage, medically underserved areas percentage, access to primary healthcare percentage, and the percentage of deaths related to alcohol, other drug use, and suicide. The medically underserved LOI indicator can be calculated as the ratio of estimated underserved population and the total population of the community. The LOI indicator for the probability of low birth weight can be calculated by assuming the Gaussian distribution of birth weight and obtaining the probability values from the Gaussian distribution, N (μ, σ), Where, μ=average birth weight and σ=standard deviation of birth weight

It is noted that these LOI indicators are merely one potential example. However, these example LOI indicators may be organized into different dimensions and/or combined with other LOI indicators in similar or different dimensions. In some embodiments of the present disclosure, the LOI can be calculated using more LOI indicators and/or potentially more dimensions.

Additionally, the LOI manager 110 can generate individual LOI's for each dimension based on the LOI indicators of the dimension. The LOI can be based, in part, on some of the LOI indicators already present in other opportunity indices, but modified to suit the local area level requirements. In some embodiments of the present disclosure, the LOI manager 110 uses new LOI indicators not incorporated into existing opportunity indices. In comparison to the Opportunity Index®, for example, the LOI manager 110 can provide a more enriched quality of data than other opportunity indices by including a more robust set of LOI indicators such as, fiscal equity, medically underserved areas, and so on. Additionally, the LOI manager 110 can combine the LOI indicators into the LOI, while taking into consideration the potential correlation between different indicators. In some embodiments, the LOI manager 110 can use principal component analysis with orthogonal varimax rotation to generate the LOI accordingly.

Additionally, the LOI manager 110 can project the LOI for future years using the machine learning models 108. These features, in combination with the scenario planning tool 112, can provide community leaders an understanding of how various investment scenarios can change socio-economic opportunities for the citizens of their community. In this way, the LOI manager 110 and scenario planning tool 112 can overcome the challenges of existing indices and provide new capabilities to help inform the investment decisions of community leaders.

More specifically, the scenario planning tool 112 can enable community leaders to identify indicators where their communities may be lacking compared to other benchmarks, for example, at the regional, state, and country level. In some embodiments, the scenario planning tool 112 can provide interfaces that visualize such comparisons. The scenario planning tool 112 can also provide interfaces that enable users, e.g., community leaders, to experiment with the underlying indicators in a multivariate setup. In this way, community leaders can discover how the LOI for their community is impacted in various scenarios. Additionally, the scenario planning tool 112 can generate recommendations for specific allocations of resources that the LOI manager 110 forecasts to produce a positive impact on the LOI and/or to achieve an LOI goal.

In some embodiments of the present disclosure, the scenario planning tool 112 can provide a scenario analysis capability that provides a projection of the LOI indicators for a specific community based on an incomplete set of publicly available data. Additionally, the scenario planning tool 112 can provide an interface enabling a community leader to update the LOI indicators using more current, detailed data for their specific community. Accordingly, the LOI manager 110 can determine the impact of the input data on the LOI and calculate a new LOI based on the updated data.

In some embodiments of the present disclosure, the optimization engine 114 can be used by local community leaders to generate a recommendation on an optimum mix of investments to achieve a specified LOI score. The optimization engine 114 can include an ensemble of optimization algorithms, including linear convex optimization technique like simplex algorithm.

Further, the LOI manager 110 can use a best of breed approach that selectively leverages multiple machine learning models 108 to generate forecasts of the impact of investments on each of the indicators in the LOI. The machine learning models 108 can represent different algorithms that are trained to perform LOI forecasts in different ways. The machine learning models 108 may be trained using historical projections of LOI. Accordingly, the LOI manager 110 can use multiple machine learning models 108 to generate LOI predictions. By predicting LOI using multiple machine learning models 108, the LOI manager 110 can increase the range of possible LOI values for LOI forecasting. For example, the machine learning models 108 can include Auto Regressive Integrated Moving Average (ARIMA) family of models and Holt Winters models.

For the purpose of clarity, the examples are described herein with respect to a specific community: Atmore, Ala., U.S.A. Atmore is a town in Escambia County; and, at the time of the 2010 U.S. Census, had a population of 10,194 people. In this example, a community leader in Atmore such as, the Mayor, a City Council member, school administrator, or healthcare administrator, may desire to improve opportunity for citizens of their community. Accordingly, the Mayor may want to collect publicly available statistics about Atmore to inform decision making of the Mayor's office and the City Council. Accordingly, the Mayor looks for a way to identify Atmore in public available data sources. The Mayor may search the Internet, specifically, the U.S. Census Bureau website, and determine that Atmore is in the PUMA for Southwest Alabama, i.e., PUMA 02200. The website states the PUMA for Southwest Alabama includes seven counties. As such, publicly available information about this PUMA may not provide specific-enough information to practically inform decision-making for improving opportunity in Atmore. Accordingly, the Mayor may make use of the example system 100, which can give an estimated index of opportunity in Atmore and identify potential areas of improvement for the community.

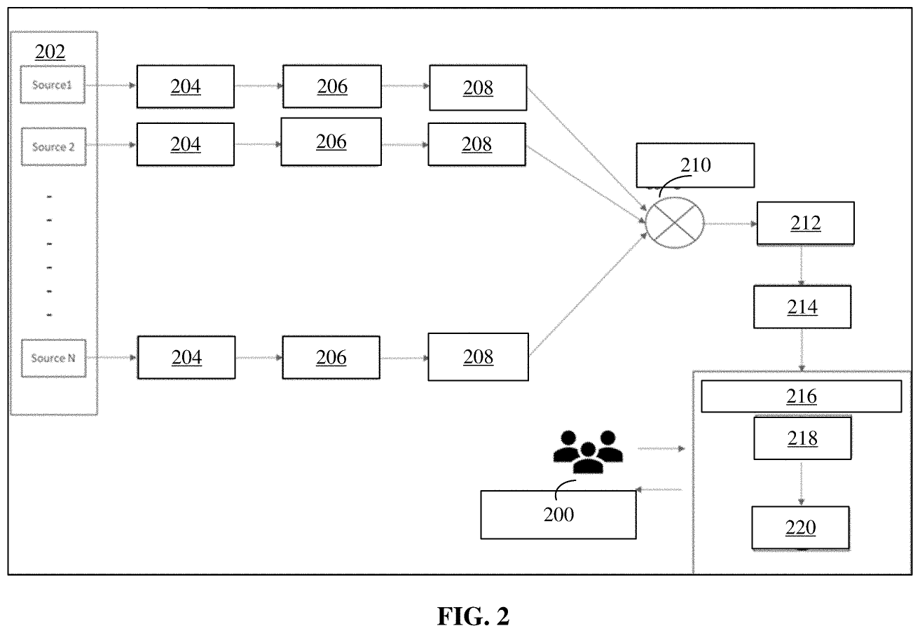

FIG. 2 is a block diagram of an example process for generating a Local Opportunity Index, in accordance with some embodiments of the present disclosure. This example process can be used to generate the LOI for a community in the United States. However, embodiments of the present disclosure can generate the LOI for communities throughout the world. The U.S. government data sources 202 can be similar to the local community data 106 described with respect to FIG. 1. In this example, data from U.S. government data sources 202 can be input to a pipeline of processing (processes 204 through 208) for each Source1 through N.

The data treatment process 204 can clean the data in the U.S. government data sources 202. However, data coming from different public data sources can contain irregularities such as, outliers and missing values. In some embodiments, the LOI manager 110 uses standard statistical procedures to handle outliers and missing values.

As a standard statistical procedure to remove outliers, the LOI manager 110 can use the Inter Quartile Range method as follows. For each LOI indicator, X, the LOI manager 110 can determine the inter quartile range (IQR) of the data set as IQR=Q3−Q1, where Q3 and Q1 represent the third and first quartiles, respectively. The LOI manager 110 can determine that any value beyond the range defined by R1 (X<R1) and R2 (X>R2) as per EQUATIONS 1 and 2 below is an outlier.

R1=Q1−1.5*IQR EQUATION 1

R2=Q3+1.5*IQR EQUATION 2

Further, any value beyond R1 and R2 is capped to R1 and R2, respectively, using EQUATION 3:

X__{after treatment}=max(min(X__{before_treatment},R2),R1) EQUATION 3

The minimum value can be capped to 0 for LOI indicators that cannot be negative values.

With respect to missing values, the LOI manager 110 can impute LOI indicator values by using a geographical hierarchy relevant to the community being analyzed. Thus, when LOI indicator values are missing at a specific level of the hierarchy, the missing value can be replaced with a value from a different level of the hierarchy. Thus, the relevant geographical hierarchy for Atmore can include (from top to bottom): country (U.S.A.), state (Alabama), PUMA, county, and ZIP Code. Accordingly, if the LOI indicator value is missing for the ZIP Code, the LOI manager 110 imputes the value for the ZIP Code from the LOI indicator value for the county, If the LOI indicator value is missing for the county, the LOI manager 110 imputes the value from an average value for the state. Similarly, if the LOI indicator value is missing for the PUMA, the LOI manager 110 can impute the value from an average value for the state.

The data treatment process 204 can provide the de-noised data to an LOI indicator process 206. The LOI indicator process 206 can determine each of the LOI indicators for the community represented in the respective Source based on the de-noised data. For example, the LOI indicator process 206 can calculate the twenty-nine LOI indicators described with respect to FIG. 1.

As stated previously, the U.S. government data sources 202 may have the relevant data stored at a relatively higher level of granularity, e.g., the state, county, or PUMA level. In order to provide more relevant information about smaller communities, the output from the LOI indicator process 206 can be input to a data transformation process 208.

The data transformation process 208 can translate the LOI indicators to a smaller level of granularity, for example, to the ZIP Code or PUMA level. Transforming the LOI indicators in this way can make it possible to determine the LOI for smaller communities than the communities for which the U.S. government data sources 202 may be stored. For example, the LOI indicator values calculated at a higher level of granularity, e.g., at the state or county level can be transformed to correlate to a lower level of granularity, e.g., a PUMA or ZIP Code. In some embodiments, the transformation can involve using a particular allocation factor or weight to adjust the LOI indicator values from a higher to lower level of granularity. For example, the weight can be a ratio of population between the two respective geographical regions defined above. Thus, assuming indicator I in the County level and I′ in the ZIP level. Then I′ can be calculated as shown in EQUATION 4:

$${I}^{′} = \frac{{\sum }_{i = 1}^{n} {A}_{i} {I}_{i}}{{\sum }_{i = 1}^{n} {A}_{i}} \qquad EQUATION 4$$

Accordingly, the transformed LOI indicators may be input to a data transformation process 208. The data transformation process 208 can transform data indicators collected for comparatively larger geographical areas, down to the local community level, e.g., the PUMA or ZIP Code. Further, the data transformation process 208 represents the end of the processing pipeline for each of the Source1 through N. Accordingly, the outputs of each processing pipeline can be input to a data aggregation process 210. The data aggregation process 210 can combine the transformed data to enable the calculation of dimensions or LOI scores. Combining can involve using statistically robust methods for assimilating, transforming, and standardizing the LOI indicator values. In this way, the data aggregation process can create LOI scores at different levels of granularity and at different levels of geographical hierarchy.

The LOI estimation process 212 may generate an LOI for a community based on the aggregated LOI indicators. In some embodiments of the present disclosure, the LOI estimation process 212 can perform a statistical estimation of the LOI for each dimension by combining the LOI indicators of each dimension. Further, the LOIs for the dimensions can be combined to generate one LOI score for a specific community ZIP Code, for example, taking into consideration the potential correlation between different LOI indicators. The LOI for each dimension can be generated for the community, taking into consideration the potential correlation between different indicators. The LOI can be generated by normalizing the LOI indicators and weighting factors such as, the relationships between the LOI indicators.

The forecast process 214 can make a projection about future LOI indicator values for the specified community. In some embodiments, the forecast process 214 can perform a derivation of a best possible forecast for each LOI indicator at the community level by employing a combination of machine learning algorithms, e.g., a best of breed approach.

Further, the outputs of the LOI estimation process 212 and the forecast process 214 can be input to a web-based scenario planning tool 216. The web-based scenario planning tool 216 can be similar to the scenario planning tool 112 described with respect to FIG. 1.

The web-based scenario planning tool 216 can include a multivariate scenario engine 218 and an optimization engine 220. The multivariate scenario engine 218 can identify the LOI indicators where a community is lacking in comparison to state and country level benchmarks. Additionally, the multivariate scenario engine 218 can enable users 200 (e.g., the Mayor) to create multiple scenarios by modifying the underlying LOI indicators and discover how LOI for their community is impacted in each of these scenarios. Additionally, the optimization engine 220 can generate a recommendation for allocating resources based on where the allocation produces a greatest amount of increase in the LOI.

In some embodiments, a recommendation at a PUMA or ZIP Code level can be determined using an Optimization Engine which may be an ensemble of optimization algorithms including linear convex optimization technique like Simplex algorithm. The problem formulation in some embodiments can be as given below: OBJECTIVE FUNCTION 1

Maximize LOI=(Σᵢ₌₁ⁿWᵢ*Hᵢ+Σᵢ₌₁ⁿW′ᵢ*Cᵢ+Σᵢ₌₁ⁿW″ᵢ*Eᵢ+Σᵢ₌₁ⁿW′″ᵢ*Edᵢ)

### Subject to,

a≤Hᵢ≤b for all i=1 to n
a′≤Cᵢ≤b′ for all i=1 to n
a″≤Eᵢ≤b″ for all I=1 to n
a′″≤Edᵢ≤b′″ for all I=1 to nWᵢ+W′ᵢ+W″ᵢ+W′″ᵢ≤B
Wᵢ, W′ᵢ, W″ᵢ, W′″ᵢ≥0,

where, H=health dimension LOI, C=community dimension LOI, E=economy dimension LOI, Ed=education dimension LOI, n=the number of indicators in the above-mentioned indexes, and B=the budget available to local leaders.

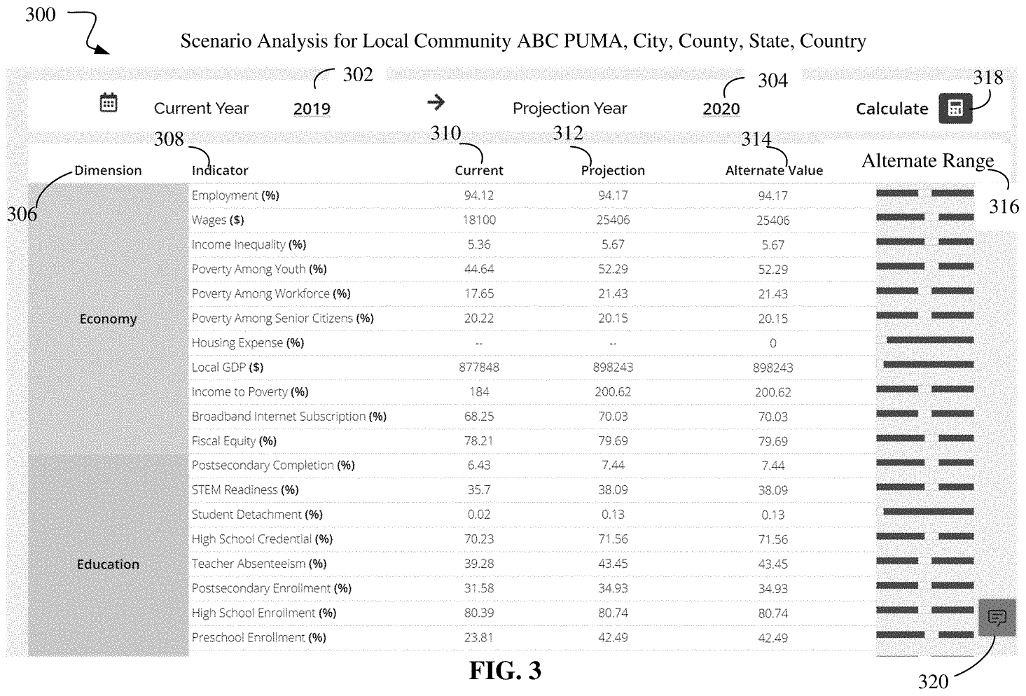

FIG. 3 is a block diagram of an example user input interface 300 for multivariate scenario analysis, in accordance with some embodiments of the present disclosure. The example interface 300 represents an input screen for multivariate scenario analysis. Accordingly, the Mayor may launch the example interface 300 to perform a multivariate scenario analysis for Atmore.

The example interface 300 includes publicly available data about the Southwest Alabama PUMA with respect to the twenty-nine LOI indicators described above. Specifically, the example interface 300 provides a generic title representing a description of the content and potential local community, e.g., “Scenario Analysis for Local Community ABC PUMA, City, County, State, Country.” Additionally, the example interface 300 includes fields for the current year 302, “2019,” and a projection year 304, “2020.” The current year 302 and projection year 304 can be pre-populated when the example interface is launched based on the most recent historical data. Thus, if the most recent historical data about the PUMA, e.g., PUMA 02200, is for 2019, the current year 302 can default to 2019, and the projection year 304 can default to the next year, 2020.

The example interface 300 also includes a table for the LOI indicators, with columns for the dimension 306, name of the indicator 308, current year indicator value 310 (“Current”), projected indicator value 312 (“Projection”), alternate value 314, and alternate range 316. The dimension 306 and name of indicator 308 are similar to the dimensions and LOI indicators described throughout this description. The current year indicator value 310 can be an estimate of the LOI indicator value based on publicly available data for 2019. The projected indicator value 312 can be the value that the multivariate scenario engine 218 projects for the requested projection year 304. The alternate value 314 can include entry fields, wherein the Mayor may update LOI indicator values manually. The alternate range 316 can provide an alternate entry field for alternate values, wherein a range of values is entered using a slider to enter a specific value in the alternate value 314. In some embodiments, the alternate range 316 can be used to enter a range of alternate values. The example interface 300 may represent a portion of the complete interface. The remaining dimensions 306 and indicators 308 may be displayed in response to a page scrolling function. Accordingly, alternate values 314 and alternate ranges 316 can be entered for the remaining LOI indicators.

In the above Atmore scenario, the Mayor can initiate a multivariate scenario analysis by entering one or more alternate values 314 or moving the slider in the alternate ranges 316. The alternate values 314 and alternate ranges 316 can represent more specific or more recent value for the community of which the Mayor is aware. For example, the indicator value 310 for housing in 2019 may represent the value for Southwest Alabama. However, the Mayor may know the housing expense (or range of housing expenses) for Atmore and enter the housing expense manually in the corresponding field for the alternate value 314 or alternate range 316. In some embodiments of the present disclosure, the slider bar of the alternate range 316 can be used to set the alternate value 314.

Additionally, the Mayor could enter alternate values 314 based on a “What-if” scenario to determine the impact of a change in specific LOI indicator values. Further, the alternate values 314 can represent targets for community improvement efforts. Thus, the Mayor can use the multivariate scenario analysis to determine the impact on LOI if specific targets are met. After entering alternate values, the Mayor can request a multivariate scenario analysis by pressing the “CALCULATE” press-button 318. In response, a multivariate scenario engine, such as the multivariate scenario engine 218, can perform the multivariate scenario analysis. Where alternate values 314 and/or alternate ranges 316 are entered, the multivariate scenario engine 218 uses the entered values to performs the analysis. Where no alternate value is entered, the multivariate scenario analysis is performed using the projected indicator value 312.

Additionally, the example interface 300 can include a chatbot icon 320. The chatbot icon 320 can be selected to request and receive automated support for using the example interface 300. Also, the chatbot's automated support can provide more information about the LOI indicators, dimensions, or LOI scores in general.

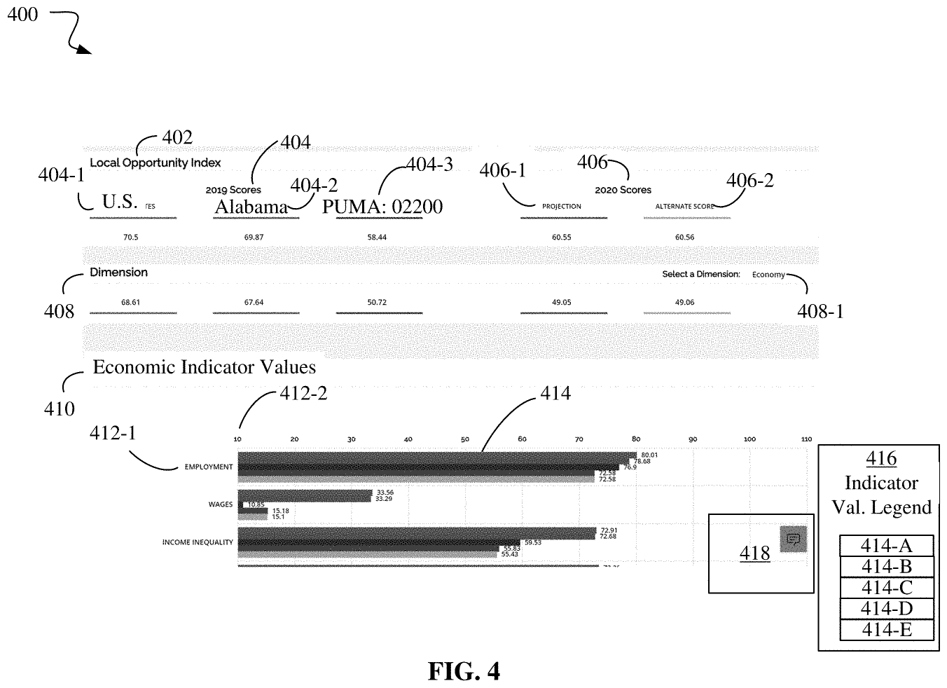

FIG. 4 is a block diagram of an example results interface 400 for multivariate scenario analysis, in accordance with some embodiments of the present disclosure. The example interface 400 can represent the output of the multivariate scenario analysis requested in the example interface 300 described above with respect to FIG. 3. Referring back to FIG. 4, the example interface 400 includes a local opportunity index section 402. The section 402 includes current LOI scores 404, “2019 Scores,” and, projected scores 406, “2020 Scores.”

The current LOI scores 404 and projected LOI scores 406 can represent the LOI that the multivariate scenario engine 218 generates for different encompassing regions of the requested local community. More specifically, the current LOI scores 404 represent the LOI for each geographic region based on the current year indicator values 310, alternate values 314, and/or alternate ranges 316, described with respect to FIG. 3. Similarly, the projected LOI scores 406 represent a statistically sound method to project the LOI for each geographic region to a future date based on the current year indicator values 310, alternate values 314, and/or alternate ranges 316. Further, the current LOI scores 404 include current country LOI score 404-1, current state LOI score 404-2, and current PUMA LOI score 404-3, which, for the “U.S.,” “Alabama,” and, “Southwest Alabama PUMA 02200,” are “70.5,” “69.87,” and, “58.44,” respectively.

In this example, the projected LOI scores 406 include current projection 406-1 (“Projection”) and alternate projection 406-2 (“Alternate Score”), which are, respectively, 60.55 and 60.56. The current projection 406-1 can be an LOI projection based on the current year indicator values 310 described with respect to FIG. 3. In contrast, the alternate projection 406-2 can be an LOI projection based on the alternate values 314 and alternate ranges 316, where entered. When these values are not provided the LOI projection can be based on the current indicator values 308.

Additionally, the example interface 400 includes a dimension section 408. The dimension section 408 can show current LOI scores 404 and projected LOI scores 406 for a specific dimension. The dimension section 408 can include an entry field 408-1 for specifying the dimension, such as a drop down list of the following selections: Economy, Health, Community, and Education. In response to selecting a specific dimension, the multivariate scenario engine 218 can determine the current LOI scores 404 and projected LOI scores 406 for the specified dimension.

The example interface 400 also includes an LOI indicator section 410, titled, “Economic Indicator Value,” in response to the selection in entry field 408-1 of the “Economy” dimension. The LOI indicator section 410 includes a bar graph, with y-axis of the LOI indicators 412-1 in the economic dimension. The x-axis represents numeric values in the range of the listed LOI economic indicator values 412-2. Thus, each LOI indicator 412-1 is associated with a multi-part bar 414 that represents the corresponding LOI economic indicator values 412-2 at the respective ends of the multi-part bars 414. The multi-part bars 414 include five parts described in and indicator value legend 416 (“Indicator Val. Legend”).

As indicated in the indicator value legend 416, the top bar 414-A represents the U.S. indicator values, the bar 414-B represents the Alabama indicator values, the bar 414-C represents the PUMA indicator values, bar 414-D represents the projected indicator values for the PUMA, and the bottom bar 414-E represents the alternate indicator values. By comparing the indicator values as shown in these multi-part bars 414, it is possible to compare local indicator values to the indicator values of other regions, e.g., at the state and country levels. Further, it is possible to compare current indicator values to projections based on publicly available data, and to alternate indicator values provided as described with respect to the example interface 300. Additionally, the example interface includes a chatbot icon 418. The chatbot icon 418 can be selected to request and receive automated support for using the example results interface 400. Also, the chatbot's automated support can provide more information about the LOI indicators, dimensions, LOI scores, the recommendation, and/or other aspects of the example results interface 400.

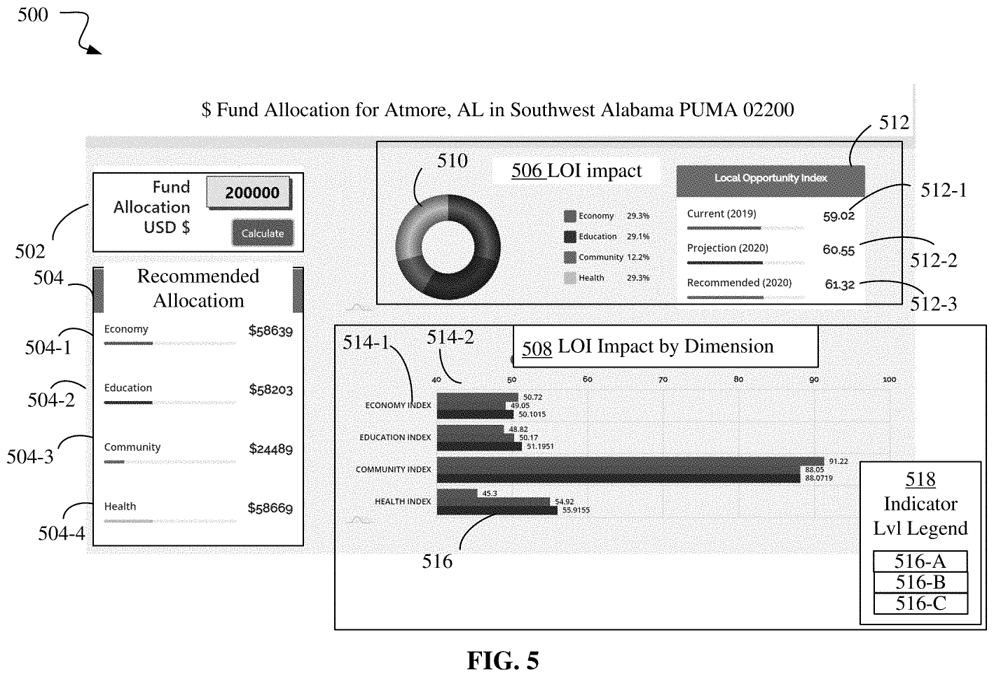

FIG. 5 is a block diagram of an example interface 500 for identifying community investment opportunities, in accordance with some embodiments of the present disclosure. The example interface 500, titled, “$ Fund Allocation for Atmore, Ala. in Southwest Alabama PUMA 02200,” can enable the user, e.g., the Mayor of Atmore, Ala. to identify potentially valuable, productive investment returns given a specific set of resources. Accordingly, an optimization engine, such as the optimization engine 114 can make a recommendation where to make the specified investment. In this way, the example interface 500 can enable community leaders to gain an understanding of how various investment scenarios may “move the needle,” e.g., change the LOI. In this way, community leaders such as the Atmore Mayor can determine where an investment can make a comparatively better change to the opportunities for citizens of their community based on where the resources are applied. In other words, the optimization engine 114 can identify specific LOI indicators and dimensions where a resource investment provides the comparatively better improvement in LOI.

According to some embodiments of the present disclosure, resources can include a wide variety. For example, resources can include labor, expertise, equipment, financial resources, and the like. The example interface 500 includes a fund allocation section 502, having an entry field and a “Calculate,” push-button, enabling the user to identify a specific dollar value potentially available for investment in Atmore, Ala. and request a recommendation from the optimization engine 114. As shown, the fund allocation specified is $200,000.

In response to a press of the “Calculate” push-button, the optimization engine 114 can populate the example interface 500 with a recommended allocation section 504, LOI impact section 506, and LOI impact by dimension section 508 based on a recommended investment of the $200,000. More specifically, the recommended allocation section 504 includes specific dollar recommendations for investment in each dimension of the LOI indicators. In this example, the recommended investment amount is also represented in a visual bar corresponding to the displayed value for the dimension.

Additionally, the LOI impact section 506 can visually represent the impact of the recommended investment on the LOI for the local community, generally, and in each dimension of the LOI indicators. In this example, the LOI impact section 506 includes a visualization of the recommended investment along each dimension, along with the corresponding percentage of the total investment. Additionally, the LOI impact section 506 includes the local opportunity index 512, which includes the current LOI score 512-1 for Atmore, Ala.; and the projected score 512-2 based on LOI indicator values, alternate values, and alternate ranges described above. Further, the recommendation LOI score 512-3 can represent the estimated LOI projected in the same time frame as the projected LOI 512-2, but under the scenario where the recommended investment is implemented.

The LOI impact by dimension section 508 includes a bar graph with y-axis for the dimensions 514-1 and x-axis for the range of LOI scores 514-2. The bar graph includes multi-part bars 516 described in the dimension scores legend 518. As shown, the top part, bar 516-A represents the current LOI for the dimension. The middle part, bar 516-B represent the projected LOI for the dimension. Further, the bottom part, bar 516-C represents the estimated LOI if the recommended investment is implemented.

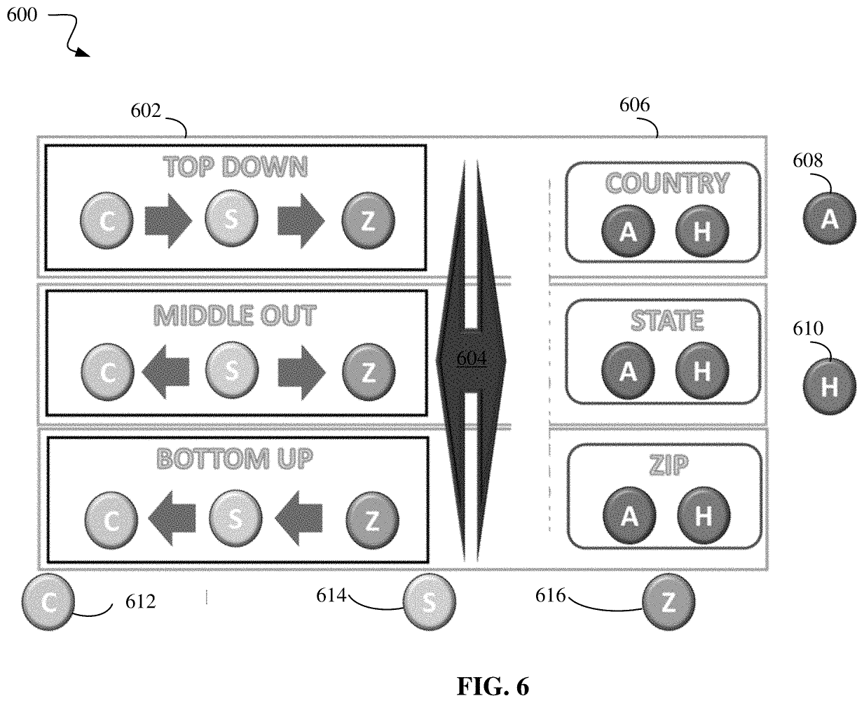

FIG. 6 is a block diagram 600 of example modeling and hierarchical processes in a system for generating a Local Opportunity Index, in accordance with some embodiments of the present disclosure. In some embodiments, the LOI manager 110 can perform hierarchical forecasting according to a geographical hierarchy. The hierarchical processes 602 include three different approaches: top down, middle out, and bottom up. The top down approach estimates LOI at a country level 612 (“C”) then apportions the LOI to the lower levels of the geographical hierarchy, e.g., state level 614 (“S”) and Zip Code level 616 (“Z”). The middle out approach estimates LOI at the state level 614, then apportions to the lower PUMA/ZIP Code level 616 and aggregates at the country level 612. The bottom up approach can forecast at the lowest PUMA/ZIP Code level 616 and roll up to the upper levels. A combination of three approaches for each of the indicators can be used and the best one (one with minimum error) for that particular indicator can be chosen.

Since the local community data 106 can come from different sources, such data may show different historical patterns. Hence, modeling processes 606 can be applied at multiple levels of a geographical hierarchy. In some embodiments, the ARIMA family of models 608 and Holt Winters models 610 can be used. Further, the LOI manager 110 can use a best of breed approach to choose the final forecast.

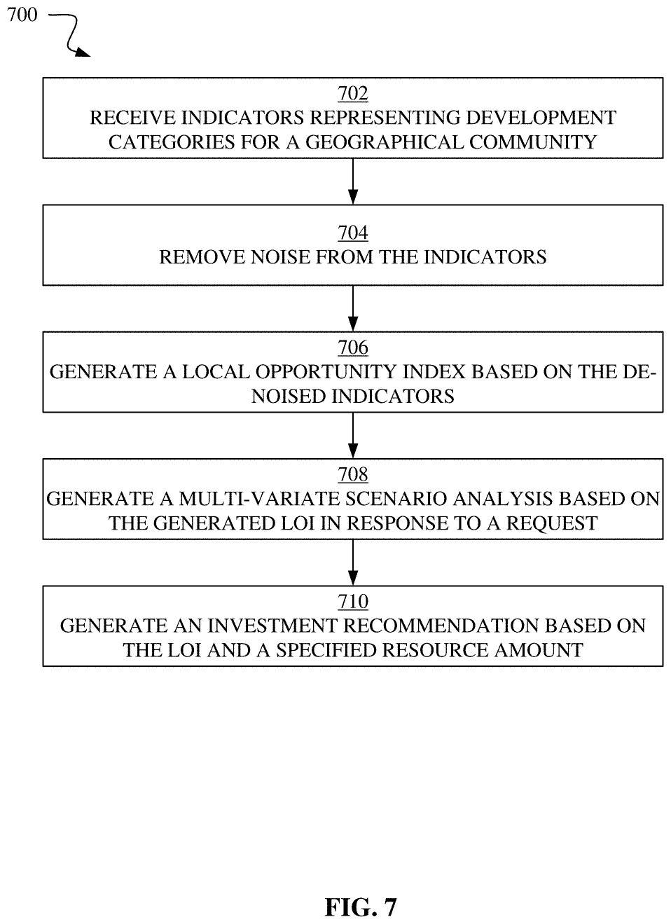

FIG. 7 is a block diagram of an example process flow diagram of a method for generating a Local Opportunity Index, in accordance with some embodiments of the present disclosure. An LOI manager, scenario planning tool, and optimization engine, such as the LOI manager 110, scenario planning tool 112, and optimization engine 114, may perform the method 700.

At operation 702, the LOI indicators described herein can be received at a system for generating an LOI. In some embodiments, the LOI manager 110 can extract, collect, or otherwise gather the LOI indicator values. For example, the LOI manager 110 may receive the LOI indicators from a manual download of the relevant data.

At operation 704, noise can be removed from the received LOI indicators. Identifying noise in the LOI indicators can involve statistical methods involving standard deviations, and outliers to mitigate the influence of such noise in estimating the LOI as described herein. The operation 704 can be similar to the data treatment process 204 described with respect to FIG. 2.

Referring back to FIG. 7, at operation 706, the LOI manager 110 can generate a Local Opportunity Index based on the LOI indicators having the noise removed. The operation 706 can be similar to the LOI indicator process 206. More specifically, the LOI manager 110 can generate LOI scores for each of the 29 LOI indicators described herein. Having determined the LOI scores for each of the LOI indicators, it is possible for the LOI manager 110 to combine the various LOI scores into one LOI score, and an LOI score for each dimension. In some embodiments, the LOI score can represent a current LOI based on the LOI indicator values. Additionally, the LOI manager 110 can generate a projected LOI score for a future time and/or date based on the LOI indicator values. The LOI manager 110 can use machine learning models, such as the machine learning models 108, to generate the projected LOI score.

At operation 708, the scenario planning tool 112 may generate a multivariate scenario analysis in response to a request. In some embodiments of the present disclosure, the request can be received from an interface, such as the example interface 300 described with respect to FIG. 3, where current LOI indicator values, alternate values, and alternate ranges can be submitted. As described above, the multivariate scenario analysis can generate new LOI scores based on the alternate values and/or alternate ranges.

At operation 710, the optimization engine 114 can generate an investment recommendation based on the LOI and a specified resource amount. For example, the optimization engine 114 can determine what LOI indicator values can achieve the comparatively more effective investment via the resultant LOI scores for each and/or the overall LOI score.

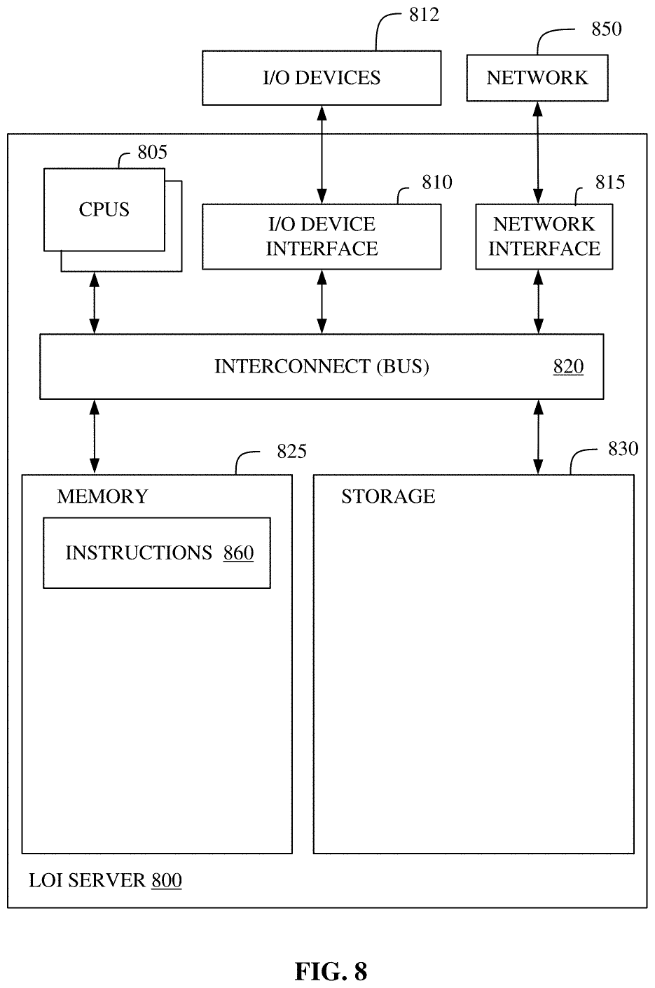

FIG. 8 is a block diagram of an example LOI server 800, in accordance with some embodiments of the present disclosure. In various embodiments, the LOI server 800 is similar to the LOI server 104 and can perform the method described in FIG. 7 and/or the functionality discussed in FIGS. 1-6. In some embodiments, the LOI server 800 provides instructions for the aforementioned methods and/or functionalities to a client machine such that the client machine executes the method, or a portion of the method, based on the instructions provided by the LOI server 800. In some embodiments, the LOI server 800 comprises software executing on hardware incorporated into a plurality of devices.

The LOI server 800 includes a memory 825, storage 830, an interconnect (e.g., BUS) 820, one or more CPUs 805 (also referred to as processors 805 herein), an I/O device interface 810, I/O devices 812, and a network interface 815.

Each CPU 805 retrieves and executes programming instructions stored in the memory 825 or the storage 830. The interconnect 820 is used to move data, such as programming instructions, between the CPUs 805, I/O device interface 810, storage 830, network interface 815, and memory 825. The interconnect 820 can be implemented using one or more busses. The CPUs 805 can be a single CPU, multiple CPUs, or a single CPU having multiple processing cores in various embodiments. In some embodiments, a CPU 805 can be a digital signal processor (DSP). In some embodiments, CPU 805 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 825 is generally included to be representative of a random access memory (e.g., static random access memory (SRAM), dynamic random access memory (DRAM), or Flash). The storage 830 is generally included to be representative of a non-volatile memory, such as a hard disk drive, solid state device (SSD), removable memory cards, optical storage, and/or flash memory devices. Additionally, the storage 830 can include storage area-network (SAN) devices, the cloud, or other devices connected to the LOI server 800 via the I/O device interface 810 or to a network 850 via the network interface 815.

In some embodiments, the memory 825 stores instructions 860. However, in various embodiments, the instructions 860 are stored partially in memory 825 and partially in storage 830, or they are stored entirely in memory 825 or entirely in storage 830, or they are accessed over a network 850 via the network interface 815.

Instructions 860 can be processor-executable instructions for performing any portion of, or all, any of the method described in FIG. 7 and/or the functionality discussed in FIGS. 1-6.

In various embodiments, the I/O devices 812 include an interface capable of presenting information and receiving input. For example, I/O devices 812 can present information to a listener interacting with LOI server 800 and receive input from the listener.

The LOI server 800 is connected to the network 850 via the network interface 815. Network 850 can comprise a physical, wireless, cellular, or different network.

In some embodiments, the LOI server 800 can be a multi-user mainframe computer system, a single-user system, or a server computer or similar device that has little or no direct user interface but receives requests from other computer systems (clients). Further, in some embodiments, the LOI server 800 can be implemented as a desktop computer, portable computer, laptop or notebook computer, tablet computer, pocket computer, telephone, smart phone, network switches or routers, or any other appropriate type of electronic device.

It is noted that FIG. 8 is intended to depict the representative major components of an exemplary LOI server 800. In some embodiments, however, individual components can have greater or lesser complexity than as represented in FIG. 8, components other than or in addition to those shown in FIG. 8 can be present, and the number, type, and configuration of such components can vary.

Although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third-party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third-party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

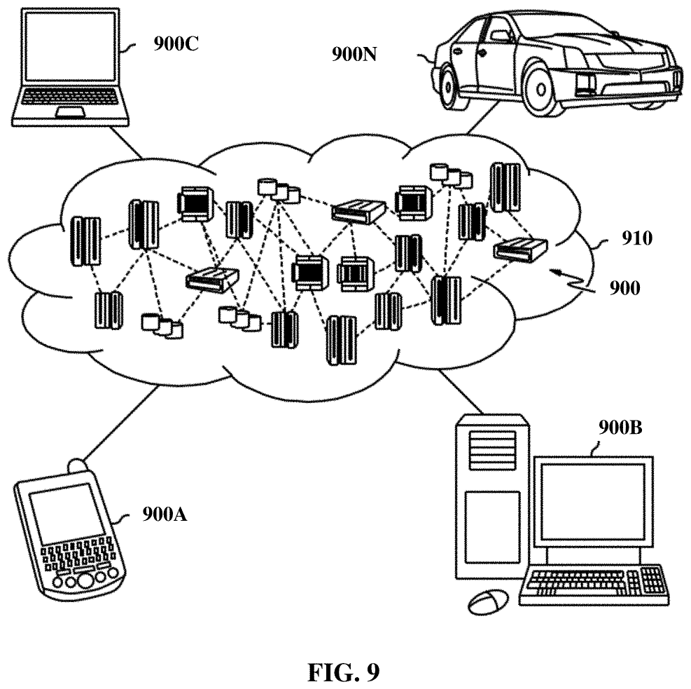

FIG. 9 is a cloud computing environment 910, according to some embodiments of the present disclosure. As shown, cloud computing environment 910 includes one or more cloud computing nodes 900. The cloud computing nodes 900 can perform the method described in FIG. 7 and/or the functionality discussed in FIGS. 1-6. Additionally, cloud computing nodes 900 can communicate with local computing devices used by cloud consumers, such as, for example, personal digital assistant (PDA) or cellular telephone 900A, desktop computer 900B, laptop computer 900C, and/or automobile computer system 900N. Further, the cloud computing nodes 900 can communicate with one another. The cloud computing nodes 900 can also be grouped (not shown) physically or virtually, in one or more networks, such as Private, Community, Public, or Hybrid clouds as described hereinabove, or a combination thereof. This allows cloud computing environment 910 to offer infrastructure, platforms and/or software as services for which a cloud consumer does not need to maintain resources on a local computing device. It is understood that the types of computing devices 900A-N shown in FIG. 9 are intended to be illustrative only and that computing nodes 900 and cloud computing environment 910 can communicate with any type of computerized device over any type of network and/or network addressable connection (e.g., using a web browser).

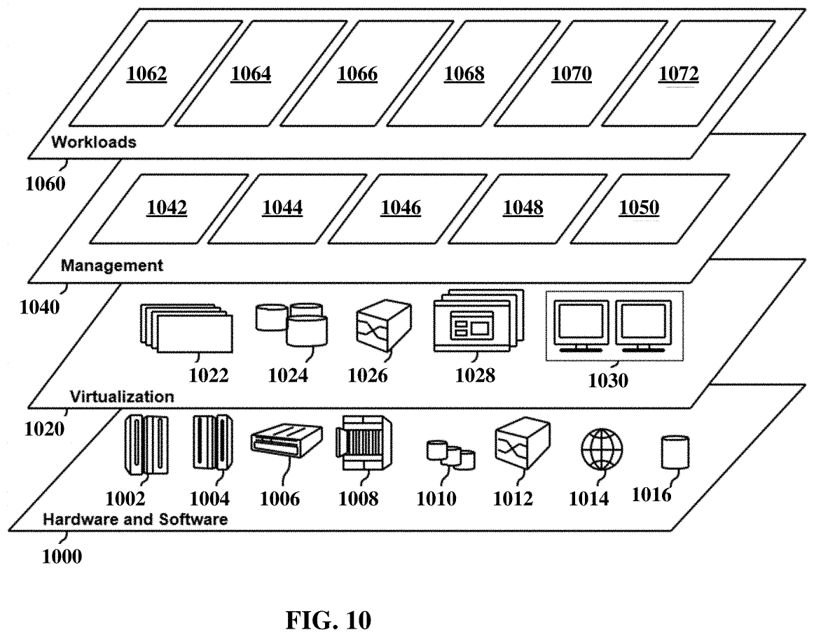

FIG. 10 is a set of functional abstraction model layers provided by cloud computing environment 910 (FIG. 9), according to some embodiments of the present disclosure. It should be understood in advance that the components, layers, and functions shown in FIG. 10 are intended to be illustrative only and embodiments of the disclosure are not limited thereto. As depicted below, the following layers and corresponding functions are provided.

Hardware and software layer 1000 includes hardware and software components. Examples of hardware components include: mainframes 1002; RISC (Reduced Instruction Set Computer) architecture based servers 1004; servers 1006; blade servers 1008; storage devices 1010; and networks and networking components 1012. In some embodiments, software components include network application server software 1014 and database software 1016.

Virtualization layer 1020 provides an abstraction layer from which the following examples of virtual entities can be provided: virtual servers 1022; virtual storage 1024; virtual networks 1026, including virtual private networks; virtual applications and operating systems 1028; and virtual clients 1030.

In one example, management layer 1040 can provide the functions described below. Resource provisioning 1042 provides dynamic procurement of computing resources and other resources that are utilized to perform tasks within the cloud computing environment. Metering and Pricing 1044 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 1046 provides access to the cloud computing environment for consumers and system administrators. Service level management 1048 provides cloud computing resource allocation and management such that required service levels are met. Service level management 1048 can allocate suitable processing power and memory to process static sensor data. Service Level Agreement (SLA) planning and fulfillment 1050 provide pre-arrangement for, and procurement of, cloud computing resources for which a future requirement is anticipated in accordance with an SLA.

Workloads layer 1060 provides examples of functionality for which the cloud computing environment can be utilized. Examples of workloads and functions which can be provided from this layer include: mapping and navigation 1062; software development and lifecycle management 1064; virtual classroom education delivery 1066; data analytics processing 1068; transaction processing 1070; and LOI server 1072.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Java, Python or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method, comprising:
receiving a plurality of local opportunity index (LOI) indicator values representing a plurality of categories of development for a geographical community;
removing noise from the LOI indicator values;
generating an LOI score based on the LOI indicator values having the noise removed, wherein the LOI score is based on a plurality of LOI indicator scores corresponding to a plurality of types of the LOI indicator values;
generating a plurality of projected LOI indicator values corresponding to the plurality of LOI indicator values, based on an incomplete set of publicly available data, by training a machine learning model using historical projections of LOI;
presenting an interface comprising the LOI score, the plurality of LOI indicator values, and the plurality of projected LOI indicator values;
receiving one or more alternate LOI indicator values via the interface; and
generating a multivariate scenario analysis comprising a new LOI score based on the LOI indicator values, one or more of the plurality of projected LOI indicator values, and the alternate LOI indicator values.

2. The method of claim 1, further comprising generating an investment recommendation based on the local opportunity index and a specified resource amount.

3. The method of claim 1, further comprising determining a dimension LOI score based on a subset of the LOI indicator values associated with a specific dimension.

4. The method of claim 1, further comprising determining the plurality of LOI indicator scores based on the LOI indicator values and a plurality of machine learning models that are trained to perform LOI forecasts.

5. The method of claim 1, further comprising determining an imputed value for one of the LOI indicator values based on a first geographic level and a second geographical level.

6. The method of claim 1, wherein determining the LOI score comprises selecting a forecast value from a plurality of forecast values generated by a corresponding plurality of machine learning models based on a higher of the forecast values.

7. (canceled)

8. The method of claim 1, wherein the interface comprises the LOI score, LOI indicator values, and the plurality of projected LOI indicator values.

9. A computer program product comprising program instructions stored on a non-transitory computer readable storage medium, the program instructions executable by a processor to cause the processor to perform a method comprising:
receiving a plurality of local opportunity index (LOI) indicator values representing a plurality of categories of development for a geographical community;
removing noise from the LOI indicator values;
generating an LOI score based on the LOI indicator values having the noise removed, wherein the LOI score is based on a plurality of LOI indicator scores corresponding to a plurality of types of the LOI indicator values;
generating a plurality of projected LOI indicator values corresponding to the plurality of LOI indicator values, based on an incomplete set of publicly available data, by training a machine learning model using historical projections of LOI;
presenting an interface comprising the LOI score, the plurality of LOI indicator values, and the plurality of projected LOI indicator values;
receiving one or more alternate LOI indicator values via the interface;
generating a multivariate scenario analysis comprising a new LOI score based on the LOI indicator values, one or more of the plurality of projected LOI indicator values, and the alternate LOI indicator values; and
generating an investment recommendation based on the new LOI score and a specified resource amount.

10. The computer program product of claim 9, the method further comprising determining a dimension LOI score based on a subset of the LOI indicator values associated with a specific dimension.

11. (canceled)

12. The computer program product of claim 9, the method further comprising determining an imputed value for one of the LOI indicator values based on a first geographic level and a second geographical level.

13-14. (canceled)

15. The computer program product of claim 9, wherein the interface comprises the LOI score, LOI indicator values, and the plurality of projected LOI indicator values.

16. A system comprising:
a computer processing circuit; and
a computer-readable storage medium storing instructions, which, when executed by the computer processing circuit, are configured to cause the computer processing circuit to perform a method comprising:
receiving a plurality of local opportunity index (LOI) indicator values representing a plurality of categories of development for a geographical community;
removing noise from the LOI indicator values;
generating an LOI score based on the LOI indicator values having the noise removed, wherein the LOI score is based on a plurality of LOI indicator scores corresponding to a plurality of types of the LOI indicator values;
generating a plurality of projected LOI indicator values corresponding to the plurality of LOI indicator values, based on an incomplete set of publicly available data, by training a machine learning model using historical projections of LOI;
presenting an interface comprising the LOI score, the plurality of LOI indicator values, and the plurality of projected LOI indicator values;
receiving one or more alternate LOI indicator values via the interface; and
generating a multivariate scenario analysis comprising a new LOI score based on the LOI indicator values, one or more of the plurality of projected LOI indicator values, and the alternate LOI indicator value; and
generating an investment recommendation based on the local opportunity index and a specified resource amount.

17. (canceled)

18. The system of claim 16, the method further comprising determining an imputed value for one of the LOI indicator values based on a first geographic level and a second geographical level.

19. (canceled)

20. The system of claim 16, wherein the interface comprises the LOI score, LOI indicator values, and the plurality of projected LOI indicator values.
